(19) United States
(12) Patent Application Publication
(10) Pub. No.: US 2024/0164383 A1
(43) Pub. Date: May 23, 2024

(54) AZADIRACHTIN FOR SEED DRESSING OF FIELD CROPS

(71) Applicant: Levente Vörös, Gyömöre (HU)

(72) Inventor: Levente Vörös, Gyömöre (HU)

(21) Appl. No.: 18/550,560

(22) PCT Filed: Jan. 31, 2022
(86) PCT No.: PCT/HU2022/050007

§ 371 Date: Sep. 14, 2023

(30) Foreign Application Priority Data
Mar. 19, 2021 (HU) P2100117

(51) Int. Cl. A01N 43/90; A01P 7/04

(52) U.S. Cl. CPC A01N 43/90; A01P 7/04

(57) ABSTRACT

The invention relates to use of azadirachtin A for controlling a soil-dwelling pest of afield crop such as corn or sunflower by seed dressing. The invention also encompasses a method for controlling a soil-dwelling pest of a field crop, comprising applying an effective amount of azadirachtin A or azadirachtin A and azadirachtin B to the seeds of said field crop by seed dressing, and then sowing the dressed seeds.

### FIELD OF THE INVENTION

The invention relates to the control of soil-dwelling pests of field crops such as e.g. corn (maize) and sunflower.

### BACKGROUND OF THE INVENTION

Azadirachtin A (CAS number: 11141-17-6) and azadirachtin B (CAS number 95507-03-2) are active ingredients of highly similar structure; they are active ingredients of the extracts of plant parts, especially seed, of the Neem tree (Azadirachta indica), a native plant in India.

Among Diabrotica species (Diabrotica spp.), those causing damage in corn, that is, corn rootworms are aggressive pests of the plants. These include, inter alia, the following species: Diabrotica barberi, Diabrotica udecimpunctata (including e.g., Diabrotica udecimpunctata howardi and Diabrotica udecimpunctata udecimpunctata), Diabrotica virgifera zeae and Diabrotica virgifera virgifera (Western corn rootworm). Western corn rootworm spread to Europe from North America. It was first detected in Europe in 1992, in the vicinity of the airport of Belgrade, and that was the origin of its spreading. Western corn rootworm has been present in Hungary since 1995. Nowadays, it is abundant in the Balkans and in Hungary and Slovakia, but is also present in several other countries. Corn rootworms including Western corn rootworm are single-generation pests, which means that they only have one biological life cycle (egg—larva—pupa—imago) per year. Their main host plant is corn. The massive economic damage is caused by the larvae, which tunnel into and chew the roots (see FIG. 1). As a result of such damage to the roots, plants will lodge.

The imago causes damage to corn. With their chewing mouthparts, these imagos damage (chew back) the pistil (corn silk or corn hair by the popular name), and this prevents pollination of the corn cob resulting in corn ears with incomplete kernel set. When chewing the pistils, corn rootworms also chew into the corn ear (more precisely, also chew on the vegetable grains below the husk leaves), which opens a pathway also for various fungal diseases (e.g., Ustillago maydis or Fusarium spp.) as well.

It also follows from the above that one of the key yield determinants of corn is the timely control of corn rootworm; that is, controlling corn rootworm larvae is of primary importance.

In most cases, soil-dwelling pests are polyphagous species (i.e., they damage multiple types of plants). These include wireworm species (Agriotes spp.), which are the larvae of click beetles, and white grubs (Melolontha spp.), which are the larvae of cockchafers. In the soil, the larvae of these polyphagous pests develop and cause damage for years. They chew the roots of plants, which results in the plants becoming unable to absorb sufficient amounts of water and nutrients; the physiological activities of the plants deteriorate, and the parts above the surface develop yellow and brown discolouration. In general, these groups of symptoms occur in patches, and result in significant destruction among the plants. The damage is more severe in classical hoed plants (e.g. corn, sunflower, sugar beet), but problems may also arise in, for example, cereal crops.

In the past, neonicotinoids targeting all pests were used for controlling soil-dwelling pests such as the larvae of corn rootworms, e.g., Western corn rootworm, wireworms and white grubs; however, these were associated with several drawbacks, e.g. bee loss, and were therefore removed from the market by the European Union. This makes the control of soil-dwelling pests of field crops significantly more difficult.

Today, the most widespread solution for controlling the larvae of corn rootworms such as Western corn rootworm is the use of formulations containing the contact-acting pyrethroid type active ingredient tefluthrin, e.g., Force 1.5 G (Syngenta CH). Tefluthrin is a contact neurotoxin, and has good efficacy against pests that have a soft external epidermis. However, it is therefore also toxic to useful soil-dwelling organisms such as earthworms, which have a vital role in the maintenance of healthy soil conditions. In addition, the use of the above-mentioned, doubtlessly efficacious product is expensive and also hazardous to aqueous organisms. In addition to the above-mentioned disadvantages, wide-spread use poses the risk of pests developing resistance to this active ingredient.

As regards soil-dwelling pests other than corn rootworms, it can also be concluded that there exists no soil-disinfecting or seed-dressing agent of suitable efficacy that can efficiently defeat these pests, e.g., wireworms. The control of also these pests is based on the wide-spread use of contact agents, and only these agents were maintained as authorised in the European Union; these include a granulated formulation called Belem, which contains the contact-acting pyrethroid cypermethrin as active ingredient. This product is less effective against wireworms because the contact action does not get on due to the thick cuticle of wireworms. Belem is not effective against corn rootworm.

Organic phosphoric acid esters (e.g., chlorpyrifos and chlorpyrifos-methyl) were successfully used against soil-dwelling pests in the past; soil humidity made these agents gaseous and the pests were killed via inhalation. With a view to the harmful effects thereof on bees, waters and humans, the European Union removed these active ingredients from the market. Due to gasification, these agents were also harmful to useful organisms while not being effective against the larvae of corn rootworms because there is a considerable interval between sowing and the appearance of the first larvae, and the generated gas escapes by then.

The above-mentioned Force product is again less effective against pests with a thick cuticle such as wireworms due to its contact-acting active ingredient.

WO2016018872 A1 relates to an aromatic amid molecule of general Formula I as an insecticide active ingredient against pests of the Phyla Nematoda, Arthropoda and/or Mollusca, to the preparation thereof, to the formulations comprising said active ingredient, and to the use thereof against pests. These active ingredients may be used, for example, as nematicides, acaricides, insecticides, miticides and/or molluscicides, optionally in combination with other active ingredients. Among the approximately 2000 speculative combination partners, azadirachtin is also mentioned. The possible use of the formulations for, among many others, seed treatment is also mentioned.

WO2012168210 A1 relates to a seed dressing formulation aid comprising at least one sticker and a silicon oil, to seed dressing formulations comprising such seed dressing formulation aid, and to the use of silicon oil for increasing the flowability of seeds and for reducing of dust. In the approximately 1000-item list of active ingredients that can be used in the seed dressing formulation, azadirachtin is also mentioned among the insect growth regulators, more specifically ecdysone antagonists.

The above documents do not mention that azadirachtin A or azadirachtin B could be used for controlling soil-dwelling pests of field crops.

Consequently, new plant protection opportunities had to be found to successfully control the soil-dwelling pests of field crops and to reduce the number of said pests below the economic threshold—and all this in a manner without burdening the environment, without endangering bees, and without causing harmful effects on the health of the personnel conducting the plant protection works.

### BRIEF DESCRIPTION OF THE INVENTION

Based on our experiments, now it has been found that seed dressing of seeds of field crops using the active ingredient azadirachtin A or a combination of azadirachtin A and azadirachtin B achieves the above objectives.

It was also found that using a composition comprising active ingredient azadirachtin A, such as e.g. commercially available Neemazal T/S (Trifolio-M GmBH, Germany), or comprising active ingredients azadirachtin A and azadirachtin B, such as e.g. commercially available Neemazal F (Coromandel International Limited Bio Products Division Thyagavalli, India), for seed dressing of seeds of field crops, seeds with a coating of natural origin and harmless to the environment are obtained, which is effective against soil-dwelling pests.

Hence, the objectives set out in relation to the invention are achieved by the use or method of the independent claims. Certain preferred embodiments of the invention are defined in the dependent claims.

### BRIEF DESCRIPTION OF THE DRAWINGS

FIG. 1 shows healthy corn roots and corn roots chewed by corn rootworm larvae.

FIG. 2 shows the average larval count per plant determined by the experiments of Example 1 for various treatments and for the untreated control.

FIG. 3 shows the average m.Iowa scores determined by the experiments of Example 1 for various treatments and for the untreated control.

FIG. 4 shows the average larval count per plant determined by the experiments of Example 2 for various treatments and for the untreated control.

FIG. 5 shows the average m.Iowa scores determined by the experiments of Example 2 for various treatments and for the untreated control.

FIG. 6 shows the results of the experiments of Example 5.

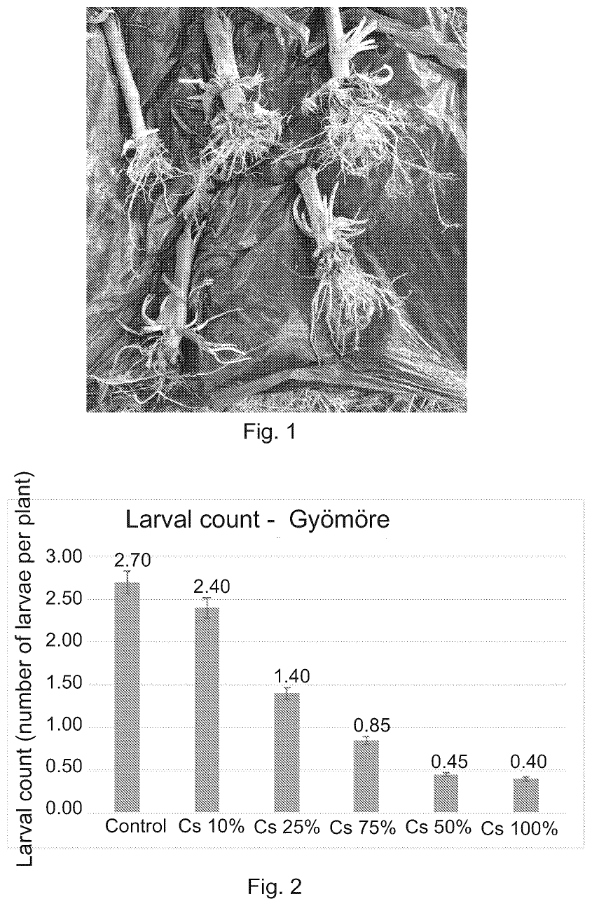

### MODES FOR CARRYING OUT THE INVENTION

Thus, the invention relates to the use of azadirachtin A for controlling a soil-dwelling pest of a field crop by seed dressing of a seed of said field crop. Azadirachtin A may be used as a single active ingredient, or in a combination, such as in combination with, for example, azadirachtin B. The invention also comprises a method for controlling a soil-dwelling pest of a field crop, comprising applying an effective amount of a composition comprising azadirachtin A to seeds of said field crop by seed dressing, and then sowing the dressed seeds.

If azadirachtin A is used in combination with azadirachtin B, then the mass ratio of azadirachtin A to azadirachtin B in the combination ranges preferably from 2.5:1 to 10:1, more preferably from 3:1 to 4:1, such as e.g. about 4:1.

In a preferred embodiment of the method or use of the invention, the soil-dwelling pest is one or more selected from corn rootworm species (i.e., Diabrotica species causing damage to corn) larva, wireworms (Agriotes spp.), and white grubs (Melolontha spp.). This also means that the use or method of the invention may be directed to one or more types of soil-dwelling pests, such as e.g. to a single type soil-dwelling pest, e.g., to corn rootworm larva, or e.g. to two types of soil-dwelling pest, e.g., corn rootworm larva and wireworm; etc.

Seed dressing is a plant protection method of preventive type. Seed dressing is used for the coating, treatment of seeds with an active ingredient against pests and pathogens to protect seeds, as well as seedlings and plants growing from said seeds, against said pests and pathogens both in the early and late growth phases.

As a result of seed dressing dressed seeds are obtained.

Seed dressing is conducted using a composition comprising azadirachtin A and a vehicle. The composition may optionally also comprise other active ingredients, such as e.g. azadirachtin B. The compositions may optionally also comprise an emulsifier, and optionally, a colourant. For example, the composition may comprise a vegetable oil. Oil-preserved compositions comprising active ingredient azadirachtin A in various concentrations are commercially available; for example, the product NEEMAZAL F comprising azadirachtin A plus azadirachtin B in a total concentration of 50 000 ppm (50 g/L), wherein the mass ratio of azadirachtin A to azadirachtin B is approximately 4:1, or the product NEEMAZAL T/S comprising azadirachtin A at a concentration of 10 g/L may be used for seed dressing. The commercial product is optionally diluted depending on the desired concentration to be used.

Seed dressing may be carried out by any seed dressing equipment used in agriculture. In the course of a seed dressing, an effective amount of active ingredient azadirachtin A, or of a combination of active ingredients azadirachtin A and azadirachtin B, is applied to the seeds. Preferred dose quantities specified for the seed dressing below are understood as the active ingredient quantities. Doses expressed as g/ha values mean the quantity of active ingredient used for the sowing of treated (dressed) seeds over an area of 1 hectare. 70000 seeds/ha is a typical sowing norm for corn and 55000 seeds/ha is a typical sowing norm for sunflower.

In the following, preferred seed dressing doses are given for the use of azadirachtin A according to the invention. If, for example, a combination comprising azadirachtin A and azadirachtin B is used, wherein the mass ratio of azadirachtin A to azadirachtin B is preferably in the range of 2.5:1-10:1, such as e.g. 4:1, then all doses given for azadirachtin A should be understood as the dose of azadirachtin A plus azadirachtin B.

In a preferred embodiment of the method or use of the invention, azadirachtin A is used against soil-dwelling pests of corn, preferably at a dose of at least 0.022 mg azadirachtin A per seed, more preferably at a dose of 0.022-0.70 mg or 0.025-0.70 mg per seed, even more preferably at a dose of 0.022 to 0.13 mg azadirachtin A per seed, which is equivalent to a dose of 1.54-49 g azadirachtin A per hectare, 1.75-49 g azadirachtin A per hectare, and 1.54-9.1 g azadirachtin A per hectare, respectively, calculated on the basis of a sowing norm of 70000 seeds per hectare. In a preferred embodiment of the invention, corn rootworm larvae and wireworms are controlled. In another preferred embodiment of the invention, corn rootworm larvae, wireworms, and white grubs are controlled.

The term “corn rootworm larva(e)” (“corn rootworm species larva(e)”) is understood to mean the larva(e) of one or more corn rootworm species (Diabrotica species causing damage to corn). The term “wireworm” is understood to refer to one or more wireworm species. The term “white grub” is understood to refer to one or more white grub species.

In another embodiment of the use or method of the invention, for the protection of spiked crops (winter wheat, winter barley, spring wheat, spring barley, rye, triticale and other spiked plants), the active ingredient azadirachtin A is used against soil-dwelling pests—preferably wireworms and/or white grubs—using a seed dressing technology, preferably at a dose of 8-250 mg of active ingredient per kg of seed, which is equivalent to a dose of 1.6-50 g of active ingredient per hectare, calculated on the basis of a sowing norm of 200 kg seed per hectare, and more preferably at a dose of 50-150 mg of active ingredient per kg of seed, which is equivalent to a dose of 10-30 g active ingredient per hectare, calculated on the basis of a sowing norm of 200 kg of seed per hectare.

In another embodiment of the use or method of the invention, for the protection of winter or spring coleseed, mustard, or oilseed radish against soil-dwelling pests—preferably wireworms and/or white grubs—using a seed dressing technology, the active ingredient azadirachtin A is used preferably at a dose of 0.1-7 g of active ingredient per kg of seed, which is equivalent to a dose of 0.2-14 g of active ingredient per hectare, calculated on the basis of a sowing norm of 2 kg of seed per hectare, and more preferably at a dose of 0.45-1.5 g of active ingredient per kg of seed, which is equivalent to a dose of 0.9-3 g of active ingredient per hectare, calculated on the basis of a sowing norm of 2 kg of seed per hectare.

In another embodiment of the use or method of the invention, for the protection of sunflower against soil-dwelling pests, e.g., wireworms (Agriotes spp.) and/or white grubs (Melolontha spp.), the active ingredient azadirachtin A is used by a seed dressing technology preferably at a dose of 0.3-12 g of active ingredient per kg of seed, which is equivalent to a dose of 1.2-48 g of active ingredient per hectare, calculated on the basis of a sowing norm of 4 kg of seed per hectare. For the protection of sunflower against soil-dwelling pests, e.g., wireworms (Agriotes spp.) and/or white grubs (Melolontha spp.), the active ingredient azadirachtin A is used by a seed dressing technology preferably at a dose of at least 0.02 mg of active ingredient per seed, more preferably at a dose of 0.02-12 mg of active ingredient per seed, and even more preferably at a dose of 0.03-0.08 mg of active ingredient per seed, which is equivalent to a dose of 1.1-6.6 g of active ingredient per hectare and 1.65-4.4 g of active ingredient per hectare, respectively, calculated on the basis of a sowing norm of 55000 seeds per hectare.

In a further embodiment of the use or method of the invention, for the protection of soybean or pea against soil-dwelling pests, the active ingredient azadirachtin A is used by a seed dressing technology preferably at a dose of 16-500 mg of active ingredient per kg of seed, which is equivalent to a dose of 1.6-50 g of active ingredient per hectare, calculated on the basis of a sowing norm of 100 kg seed per hectare, and more preferably at a dose of 70-250 mg of active ingredient per kg of seed, which is equivalent to a dose of 7-25 g of active ingredient per hectare, calculated on the basis of a sowing norm of 100 kg seed per hectare.

In another embodiment of the use or method of the invention, for the protection of sorghum against soil-dwelling pests, the active ingredient azadirachtin A is used by a seed dressing technology preferably at a dose of 0.15-8 g of active ingredient per kg of seed, more preferably at a dose of 0.15-3 g of active ingredient per kg of seed, which is equivalent to a dose of 1.5-30 g of active ingredient per hectare, calculated on the basis of a sowing norm of 10 kg seed per hectare, and even more preferably at a dose of 0.15-1.5 g of active ingredient per kg of seed, which is equivalent to a dose of 1.5-15 g of active ingredient per hectare, calculated on the basis of a sowing norm of 10 kg seed per hectare.

The preferred dose of the active ingredient(s) used varies depending on the pest to be controlled. The dose to be applied is selected depending on the pest infestation status.

Due to its biological origin, the active ingredient azadirachtin does not have a negative impact on the environment, does not endanger useful living organisms, is not harmful to bees, and also safeguards the health of the individuals carrying out the work with it.

Based on our experiments, azadirachtin A is used as a seed dressing agent preferably against the following soil-dwelling pests:
pests of corn: corn rootworm larvae (Diabrotica spp., especially Diabrotica virgifera virgifera), wireworms (Agriotes spp.), white grubs (Melolontha spp.),
pests of sunflower: wireworms (Agriotes spp.), white grubs (Melolontha spp.),
pests of spiked cereal (winter wheat, winter barley, spring wheat, spring barley, rye, triticale, and other spiked crops): wireworms (Agriotes spp.), white grubs (Melolontha spp.),
pests of winter and spring coleseed, mustard, and oilseed radish:
wireworms (Agriotes spp.), white grubs (Melolontha spp.),
pests of soybean and pea: wireworms (Agriotes spp.), white grubs (Melolontha spp.),
pests of sorghum: wireworms (Agriotes spp.), white grubs (Melolontha spp.).

Our experiments in both corn monocultures in their third year and 60-year-old corn monocultures demonstrated that the active ingredient azadirachtin A strongly suppressed soil-dwelling pests, such as the larvae of Western corn rootworm, when applied using a seed dressing technology.

The active ingredient was applied to the surface of corn seeds using a seed dressing technology and various doses.
Dosing 1 (Treatment 1): 0.065 mg of active ingredients azadirachtin A+azadirachtin B per seed;
Dosing 2: 0.053 mg of active ingredients azadirachtin A+azadirachtin B per seed;
Dosing 3: 0.043 mg of active ingredient azadirachtin A or active ingredients azadirachtin A+azadirachtin B per seed;
Dosing 4: a) 0.038 mg of active ingredient azadirachtin A or active ingredients azadirachtin A+azadirachtin B per seed; b) 0.033 mg of active ingredient azadirachtin A or active ingredients azadirachtin A+azadirachtin B per seed;
Dosing 5: a) 0.025 mg of active ingredient azadirachtin A or active ingredients azadirachtin A+azadirachtin B per seed; b) 0.022 mg of active ingredient azadirachtin A or active ingredients azadirachtin A+azadirachtin B per seed;
Dosing 6: a) 0.0125 mg of active ingredient azadirachtin A or active ingredients azadirachtin A+azadirachtin B per seed; b) 0.011 mg of active ingredient azadirachtin A;
Dosing 7: a) 0.005 mg of active ingredient azadirachtin A or active ingredients azadirachtin A+azadirachtin B per seed; b) 0.0043 mg of active ingredient azadirachtin A.

During the evaluation,
the number of larvae per plant was determined as follows: in the phenological phase of larval stage L3, 5 plants per experimental parcel were dug out together with a 20×20 cm soil cube/ball, and live larvae were counted in the pit and in the soil cube/ball; and
the degree of root chewing (root damage) on the roots that had been dug out were also determined using the so-called Modified Iowa Scale (m.Iowa). This is a scale of 1 to 6 with increments of 0.5; the higher the degree of root damage, the higher the value which is assigned to the assessed root. More specifically, the Modified Iowa Scale (m.Iowa) is as follows: 1.0—no damage; 1.5—visible feeding scars; 2.0—three roots pruned slightly; 2.5—more than three roots pruned but non chewed to within 1.5 inches of the plant; 3.0—1 to 3 roots chewed to within 1.5 inches of the plant; 3.5—more than 3 roots chewed to within 1.5 inches of the plant; 4.0—an entire node, or roots equivalent to a node, destroyed; 4.5—about 1.5 nodes destroyed; 5.0—2 nodes destroyed; 5.5—about 2.5 nodes destroyed; 6.0—three or more nodes destroyed.

On the Modified Iowa Scale, 3.5 is the economic threshold above which control measures must be introduced in any case.

Damage assessment based on the Modified Iowa Scale is more precise than the damage assessment based on the larval count.

The evaluation of the results revealed that Treatments (Dosings) 1, 2, 3, 4 and 5 each showed clear significant difference in comparison with Treatments 6 and 7 and the untreated control, respectively.

Positive control treatment was carried out using the soil disinfecting agent Force 1.5 G (tefluthrin content: 15 g/kg) at its highest recommended dose, i.e., 15 kg/ha.

The evaluation of the results presented in Examples 1 to 4 demonstrate that with a seed dressing dose of 0.022 mg/seed (1.54 g/ha) or higher, the treatments were effective in comparison with the untreated control. In locations where larva populations were more abundant (as shown in Examples 2 and 4), outstandingly best results were achieved by the treatments with the highest doses (0.053 mg/seed and 0.065 mg/seed; 3.71 g/ha and 4.55 g/ha, respectively), which exceeded the effects of both the positive control (Force 1.5 G) and of the treatments with lower doses.

This means that at least equivalent results with considerably reduced health risks, environmental harms and costs can be achieved in comparison with the methods already in use in agriculture. Consequently, the active ingredient used according to the invention does not have a negative impact on the environment, does not endanger useful organisms, and is also harmless to the health of the individuals carrying out the work. Unlike tefluthrin (Force 1.5 G), azadirachtin does not have a harmful effect on useful soil-dwelling organisms because it enters the body of the pests via feeding, and not through contact or inhalation. Hence, organisms not feeding on the roots of the plants, e.g., earthworms, are in complete safety. The use of this active ingredient saves useful organisms that form an indispensable part of soil fauna and contribute to the preservation of the normal healthy soil conditions.

In a sunflower culture, our experiments using doses of 0.04 mg of the active ingredient azadirachtins A+B (i.e. azadirachtin A plus azadirachtin B) per seed, 0.03 mg active ingredient per seed and 0.02 mg active ingredient per seed, respectively, wherein Belem was used as a positive control, prove the efficacy of the use and method of the invention in the case of wireworms too. The results were also compared to untreated control. A statistical analysis demonstrated that the treatments were successful, and each treatment showed significant difference in comparison with the untreated control. The experiments are presented in more detail in Example 5.

In the case of certain years and certain cultivation technologies (e.g., high number of corn rootworm larvae), it may be justifiable to use higher active ingredient doses than mentioned above.

Further details of our experiments and results are given in the Examples.

One serious advantage of the present invention is the long lasting (long duration) effect of azadirachtin A used by seed dressing. Since the damage caused by corn rootworm larvae occurs at the latest point in time in comparison to all (monophagous and polyphagous) pests, the high efficacy against corn rootworm larvae as demonstrated by our experiments shows a long-lasting effect of azadirachtin A. Thus, the observed long lasting effect is also sufficient for the successful control of other soil-dwelling pests. Our experiments also support the conclusion that azadirachtin A used by the seed dressing is also effective against wireworms despite their thick cuticle because azadirachtin enters the body of soil-dwelling organisms via feeding. This is the big advantage of azadirachtin in the control of corn rootworm in comparison with tefluthrin (Force 1.5 G)—the agent most widely used in said control—because Force 1.5 G is not effective against wireworms.

Since wireworms and white grubs are polyphagous pests (causing damage to more than one field crop), it can be safely concluded that seed dressing using azadirachtin A or azadirachtin A+azadirachtin B also ensures successful protection from the damage caused by polyphagous pests (wireworms and white grubs) in other field cultures, i.e., in plants other than sunflower, such as corn, soybean, pea, sorghum, spiked plants, rape, mustard etc.

### EXAMPLES

### Example 1

Studies on Controlling Western Corn Rootworm (Diabrotica virgifera Virgifera) Larvae in Corn Culture

The experiments had a random set-up with 4 repeats.

The location of the experiments was a monoculture in its third year in Gyömöre, Hungary; the experiments were conducted in small parcels with a size of 18 m².

The experiments were conducted using Neemazal T/S formulation, diluted with water for doses of less than 100%. The doses expressed as percentages or concentration values refer to the concentration of Neemazal T/S in the seed dressing liquid; thus, the “100% dose” or “100% concentration” in this Example means seed dressing using undiluted Neemazal T/S.
Seed type: DKC-5141 hybrid.
Amount of seed dressing liquid: 4.32 ml for 0.36 kg seed.
Sowing norm: 70000 seeds per hectare.

The quantities and doses used for the seed dressing are summarised in Table 1.

TABLE 1
Amounts, doses used for the seed dressing
of DKC-5141 hybrid seeds - Example 1

| | | Neemazal | | Azadirachtin | Azadirachtin |
|---|---|---|---|---|---|
| | Mass of | T/S | Water | A | A |
| Dose | 1000 seeds | (ml) | (ml) | (mg/seed) | (g/ha) |
| 100% | 360 g | 4.32 | — | 0.043 | 3.01 |
| 75% | 360 g | 3.24 | 1.08 | 0.033 | 2.31 |
| 50% | 360 g | 2.16 | 2.16 | 0.022 | 1.54 |
| 25% | 360 g | 1.08 | 3.24 | 0.011 | 0.77 |
| 10% | 360 g | 0.432 | 3.89 | 0.0043 | 0.30 |

An untreated control receiving no treatment at all was used as negative control. Seed dressing was carried out manually. Seed dressing liquids of appropriate quantities and concentrations were prepared from the product Neemazal T/S—by diluting them with water if necessary—, and then 360 g of seed was poured into each of the liquids, and stirring was used to ensure even application of the seed dressing agent onto the seeds.

The sowing depth was 8 cm, the row distance was 76 cm, and the sowing distance was 18 cm.

From one parcel, 5 plants were dug out together with a 20×20 cm soil ball 8 weeks after sowing. The larvae of Western corn rootworm were counted in both the soil ball and the pit that was formed by the digging out. The roots of the plants that had been dug out were placed into plastic bags, were labelled, and then the soil was removed using a high-pressure washer, and root damage was assessed using the Modified Iowa Scale. The data were recorded continuously, and this was followed by a statistical evaluation.

The average larval counts are presented in FIG. 2.

Thus, the experimental (seed dressing) doses were as follows:
10% dose: 0.0043 mg azadirachtin A per seed (Cs 10% in FIG. 2),
25% dose: 0.011 mg azadirachtin A per seed (Cs 25% in FIG. 2),
50% dose: 0.022 mg azadirachtin A per seed (Cs 50% in FIG. 2),
75% dose: 0.033 mg azadirachtin A per seed (Cs 75% in FIG. 2),
100% dose: 0.043 mg azadirachtin A per seed (Cs 100% in FIG. 2).

Among the assessed parcels, the highest average larval count (2.7±3.4 larvae/plant) was detected in the untreated control (marked as ‘Control’ in FIG. 2). The lowest average larval count (0.4±0.60 larvae/plant) was detected in the parcels in which the seeds treated (dressed) with the 100% dose—i.e., with the active ingredient azadirachtin A applied using undiluted Neemazal T/S—were sown.

The analysis conducted using the SPSS program showed a significant difference (p<0.05) between the parcels on the basis of the average larval counts (p=0.000; F=5.462). Based on the results of the Tukey HSD Post hoc test, the untreated control parcel significantly differed (p<0.05) from the parcels treated with the 100% dose (Cs 100%) (SE=0.598 pTukey=0.003), 75% dose (Cs 75%) (SE=0.598 pTukey=0.029) and 50% dose (Cs 50%) (SE=0.598 pTukey=0.004), respectively, on the basis of the average larval counts. The parcel treated with the 10% dose (Cs 10%) significantly differed from the parcels treated with the 100% dose (Cs 100%) (SE=0.598 pTukey=0.014) and the 50% dose (Cs 50%) (SE=0.598 pTukey=0.018), respectively, on the basis of the average larval counts.

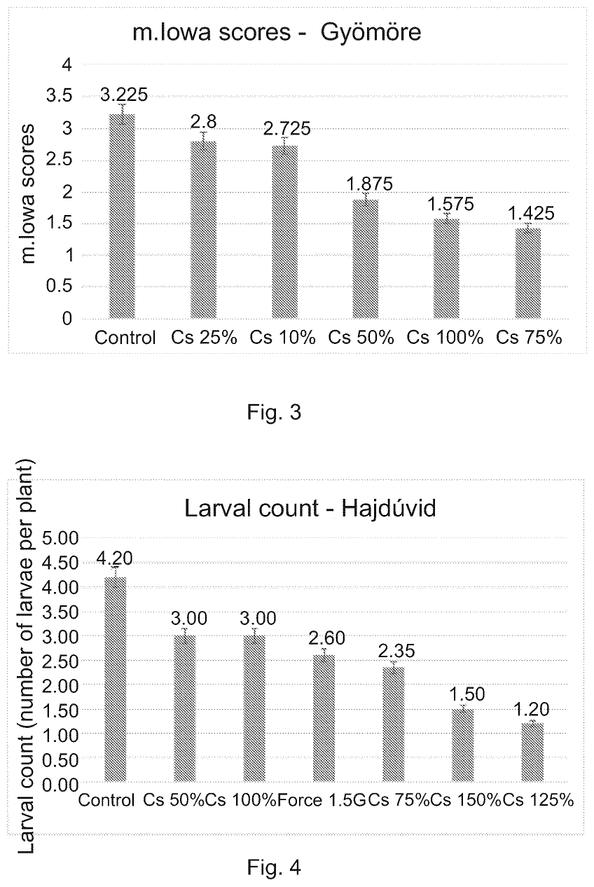

The results of the m.Iowa assessments are presented in FIG. 3.

Among the assessed parcels, the highest degree of damage (m.Iowa: 3.23±0.60) was observed in the untreated control (marked as ‘Control’ in FIG. 3) according to our experiments. The lowest degree of damage according to the m.Iowa Scale was detected in the case of the seeds treated (dressed) with the highest doses (75% and 100%).

The analysis conducted using the SPSS program showed a significant difference (p<0.05) between the parcels on the basis of the m.Iowa scores (p=0.000; F=27.358). Based on the results of the Tukey HSD Post hoc test, the untreated control parcel significantly differs (p<0.05) from the parcels treated with the 100% dose (Cs 100%) (SE=0.2006 pTukey=0.000), 75% dose (Cs 75%) (SE=0.2006 pTukey=0.000) and 50% dose (Cs 50%) (SE=0.2006 pTukey=0.000), respectively, on the basis of the m.Iowa scores. The parcel treated with the 10% dose (Cs 10%) significantly differs from the parcels treated with the 100% dose (Cs 100%) (SE=0.2006 pTukey=0.000), 75% dose (Cs 75%) (SE=0.2006 pTukey=0.000) and 50% dose (Cs 50%) (SE=0.2006 pTukey=0.001), respectively, on the basis of the m.Iowa scores. The parcel treated with the 25% dose (Cs 25%) significantly differs from the parcels treated with the 100% dose (Cs 100%) (SE=0.2006 pTukey=0.000), 75% dose (Cs 75%) (SE=0.2006 pTukey=0.000) and 50% dose (Cs 50%) (SE=0.2006 pTukey=0.000), respectively, on the basis of the m.Iowa scores.

### Example 2

Studies on Controlling Western Corn Rootworm (Diabrotica virgifera Virgifera) Larvae in Corn Culture

The experiments had a random set-up with 4 repeats.

The location of the experiments was a monoculture in its third year in Hajdúvid, Hungary; the experiments were conducted in small parcels with a size of 18 m².

The experiments were conducted using Neemazal F (azadirachtin A: azadirachtin B=approximately 4:1) mixed with water. The doses were set in a way to ensure that the combined doses of azadirachtin A+azadirachtin B in doses called 50%, 75% and 100% doses are equivalent to the 50%, 75% and 100% azadirachtin A doses, respectively, of Example 1.

Seed type: DKC-5141 hybrid.

Sowing norm: 70000 seeds per hectare.

The quantities and doses used for seed dressing are summarised in Table 2.

TABLE 2
Amounts, doses used for the seed dressing
of DKC-5141 hybrid seeds - Example 2

| | Mass of | | | | |
|---|---|---|---|---|---|
| | 1000 | Neemazal | | Azadirachtins | Azadirachtins |
| | seeds | F | Water | A + B | A + B |
| Dose | (g) | (ml) | (ml) | (mg/seed) | (g/ha) |
| 150% | 360 | 1.29 | 3.03 | 0.065 | 4.55 |
| 125% | 360 | 1.08 | 3.24 | 0.053 | 3.71 |
| 100% | 360 | 0.86 | 3.46 | 0.043 | 3.01 |
| 75% | 360 | 0.65 | 3.67 | 0.033 | 2.31 |
| 50% | 360 | 0.43 | 3.98 | 0.022 | 1.54 |

Force 1.5 G-t was used at a dose of 15 kg/ha as positive control.

An untreated control receiving no treatment at all was used as negative control.

Seed dressing was carried out manually. Seed dressing liquids of appropriate quantities and concentrations were prepared from the product Neemazal F—by diluting them with water if necessary—, and then 360 g of seed was poured into each of the liquids, and stirring was used to ensure even application of the seed dressing agent onto the seeds.

The sowing depth was 8 cm, the row distance was 76 cm, and the sowing distance was 18 cm.

From one parcel, 5 plants were dug out together with a 20×20 cm soil ball 8 weeks after sowing. The larvae of Western corn rootworm were counted in both the soil ball and the pit that was formed by the digging out. The roots of the plants that had been dug out were placed into plastic bags, were labelled, and then the soil was removed using a high-pressure washer, and chewing was assessed using the Modified Iowa Scale. The data were recorded continuously, and this was followed by a statistical evaluation.

The average larval counts are presented FIG. 4.

Thus, the experimental (seed dressing) doses were as follows:
50% dose: 0.022 mg azadirachtins A+B per seed (Cs 50% in FIG. 4),
75% dose: 0.033 mg azadirachtins A+B per seed (Cs 75% in FIG. 4),
100% dose: 0.043 mg azadirachtins A+B per seed (Cs 100% in FIG. 4),
125% dose: 0.053 mg azadirachtins A+B per seed (Cs 125% in FIG. 4),
150% dose: 0.065 mg azadirachtins A+B per seed (Cs 150% in FIG. 4).

The site (Hajdúvid) of this Example had an outstandingly high soil infestation by corn rootworm larvae.

Among the assessed parcels, the highest average larval count (4.20±2.91 larvae/plant) was detected in the untreated control parcel (marked as ‘Control’ in FIG. 4). The second highest average larval count (3.00±2.00 larvae/plant) was detected on the plants treated with the 50% dose. The lowest average larval count was detected on the plants treated with the 125% dose and the 150% dose, respectively. In the case of Cs 150% (150% dose) and Cs 125% (125% dose), the average larval count was 1.50 (±1.61) larvae/plant and 1.20 (±1.40) larvae/plant, respectively. For these doses (Cs 125% and Cs 150%), as compared to the positive control (Force 1.5 G), significantly lower (about 50%) larval counts were detected.

The one-way ANOVA analysis conducted using the SPSS program showed a significant difference (p<0.05) between the parcels on the basis of the average larval counts (p=0.000; F=4.621). The results of the Tukey HSD Post hoc test showed that on the basis of larval counts, the untreated control parcel significantly differed (p<0.05) only from treatment Cs 150% (SE=0.663 pTukey=0.002) and from treatment Cs 125% (SE=0.663 pTukey=0.000). Neither the seed dressings applied in lower doses nor the positive control (Force 1.5 G) showed significant difference in comparison with the untreated control parcel.

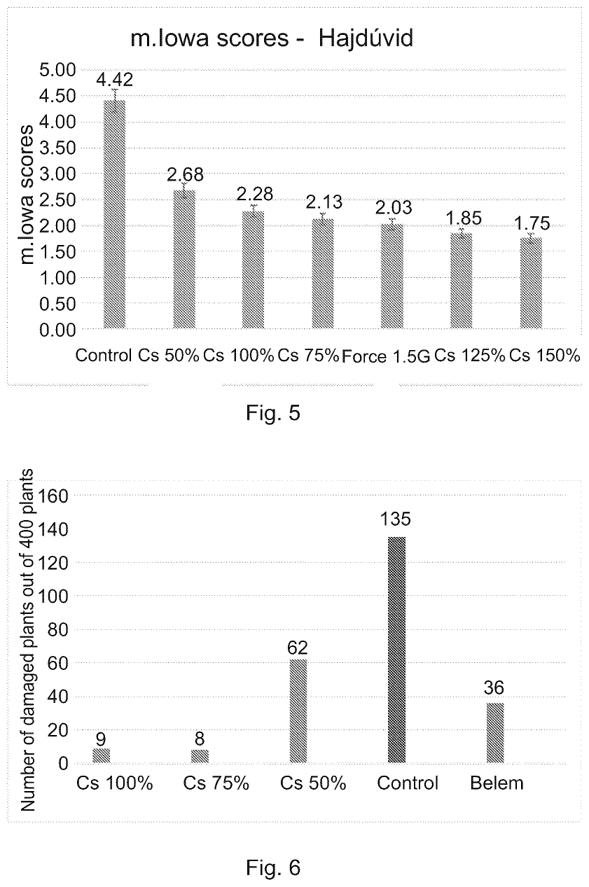

The results of the m.Iowa assessments are presented in FIG. 5.

Among the assessed parcels, the highest degree of damage was detected in the untreated control parcel (marked as ‘Control’ in FIG. 5); the average Iowa score for the degree of damage was 4.42 (±1.16). This score is far above the m.Iowa score of 3.5 considered as the limit value for economic damage. The second highest average root damage (2.68±0.75) was detected on the plants treated with the 50% dose. The lowest average root damage was detected on the plants treated with the 125% dose and the 150% dose, respectively; the efficacy of these two highest doses even exceeded the efficacy of the positive control (Force 1.5 G). In the case of Cs 150% (150% dose) and Cs 125% (125% dose), the average Iowa score was 1.75 (±0.62) and 1.85 (±0.62), respectively.

The one-way ANOVA analysis conducted using the SPSS program showed a significant difference (p<0.05) between the parcels on the basis of the m.Iowa scores (p=0.000; F=28.322). The results of the Tukey HSD Post hoc test showed that on the basis of the m.Iowa scores, the untreated control parcel significantly differs (p<0.05) from each other parcels. On the basis of the results, each treatment clearly separates from the degree of root damage in the untreated control parcel.

The results clearly reveal that the compositions used have at least as good efficacy as Force 1.5 G (tefluthrin)—a widely used soil disinfecting agent—, especially in the higher doses.

### Example 3

Studies on controlling Western corn rootworm (Diabrotica virgifera virgifera) larvae in corn culture Experiments similar to those described in Example 1 were set up in a 60-year-old corn monoculture in Röjtökmuzsaj, Hungary. Since corn has been grown at the same location for a very long time here, damage by corn rootworm larvae was assumed to be considerable.

At a difference from the experimental conditions of Example 1, only the 100% dose and the 50% dose were used in these experiments, and these were compared to an untreated control parcel and to using the soil disinfecting agent Force 1.5 G (tefluthrin) at a dose of 15 kg/ha.

In terms of both larval counts and root damage, the uses according to the invention worked very well. The average larval count per plant was 2.15 in the untreated control parcel, 0.27 in the parcel treated with Force 1.5 G and in the parcel treated with the 100% dose of azadirachtin by seed dressing, and 0.73 with the 50% dose. Statistical analyses clearly demonstrated that on the basis of larval counts per plant, each of the treated parcels significantly differs from the untreated control; seed dressing with the 100% dose resulted in considerably lower larval counts than seed dressing with the 50% dose.

As regards root damage, the average Modified Iowa Scale score was 1.8 in the untreated control parcel; in the treated parcels, the scores were 1.6, 1.33 and 1.42 with Force 1.5 G, with the 100% azadirachtin seed dressing, and with the 50% azadirachtin seed dressing, respectively, indicating that the lowest degree of damage was again observed in the case of seed dressing with the highest dose (Cs 100%).

### Example 4

Studies on Controlling Western Corn Rootworm (Diabrotica virgifera Virgifera) Larvae in Corn Culture

The experiments described in Example 2 were set up also in Röjtökmuzsaj.

The applied seed dressing doses included 50%, 75%, 100%, 125% and 150% (the corresponding doses of active ingredient azadirachtins A+B per seed were as described in Example 2), which were compared to Force 1.5 G and to an untreated control.

The average larval count per plant was 4.95 in the untreated control parcel and 2.40 in the parcel treated with Force 1.5 G.

When seed dressing with Neemazal F was used, the average larval counts per plant were as follows:
50% dose: 2.60; 75% dose: 2.20; 100% dose: 1.40; 125% dose: 1.90; 150% dose: 2.10.

Thus, a strong pest pressure by corn rootworm was observed in this experiment at Röjtökmuzsaj.

The statistical analyses clearly demonstrated significant differences between each of the treated areas and the untreated control on the basis of the per-plant average larval counts.

As regards root damage, the average Modified Iowa Scale score was 3.55 in the untreated control parcel but much lower in the treated parcels: 1.78 for the parcel treated with Force 1.5 G; 2.10 for the 50% seed dressing dose; 2.08 for the 75% seed dressing dose; 2.18 for the 100% seed dressing dose; 1.60 for the 125% seed dressing dose; and 1.78 for the 150% seed dressing dose.

The statistical analysis showed a clear significant difference between each of the treated parcels and the untreated control, but such significant difference was not observed between the treated parcels. However, the best results were observed in the cases of seed dressings with the 125% dose and with the 150% dose, respectively, which were comparable or even superior to the results of the positive control (Force 1.5 G).

### Example 5

### Studies on Controlling Wireworm in a Sunflower Culture

The experiments had a random setup with 4 repeats.

The location of the experiments was Tiszalök, Hungary; the experiments were conducted in small parcels with a size of 18 m².

The experiments were conducted using Neemazal F diluted with water in doses of less than “100%”. The doses were set in a way to ensure that the azadirachtin doses corresponding to the 50%, 75% and 100% doses are essentially equivalent to the 50%, 75% and 100% doses, respectively, of the previous Examples.

Seed type: ES Loris.

The quantities and doses used for seed dressing are summarised in Table 3.

The quantity of the seed dressing liquid was 12 L per 1000 kg seed.

Seed quantity: 55000 seeds per hectare.

Site history: the site was a meadow in the previous years (therefore, considerable pest pressure was expected, and this turned out to be the case indeed).

Site history alone already hinted to a considerable pest pressure. In order to verify even more that the site is under high wireworm pressure, a forecast was prepared.

Balls of the size of 6 to 7 cm were kneaded using oatmeal, yeast, flour and sugar; the balls were then placed into a net and were buried at several locations within the site as traps. After 2 weeks, the traps were dug out and checked for the presence of wireworms. Our forecast experiment revealed that pests are present in sufficient numbers at the site in terms of the experimental set-up.

The sowing depth was 6 cm, the row distance was 76 cm, and the sowing distance was 24 cm.

Seed dressing was carried out manually. Seed dressing liquids of appropriate quantities and concentrations were prepared from the product Neemazal F—by diluting them with water if necessary—, and then the seeds were poured into the liquids, and stirring was used to ensure even application of the seed dressing agent onto the seeds.

TABLE 3
Amounts, doses used for the seed dressing
of ES Loris seeds - Example 5

| | Mass of | | | | |
|---|---|---|---|---|---|
| | 1000 | Neemazal | | Azadirachtins | Azadirachtins |
| | seeds | F | Water | A + B | A + B |
| Dose | (g) | (ml) | (ml) | (mg/seed) | (g/ha) |
| 100% | 667 | 8 | — | 0.04 | 2.2 |
| 75% | 667 | 6 | 2 | 0.03 | 1.65 |
| 50% | 667 | 4 | 4 | 0.02 | 1.10 |

The experiment was evaluated by counting 100 plants per parcel. The number of damaged plants out of 100 plants in a parcel was determined, this involved visual observation. Damaged plants were defined as being those plants that show a physiology that is different from the normal physiology. During the evaluation, all plants showing visible symptoms—such as yellow discolouration, brown discolouration, wilting, complete destruction—were considered as damaged.

The results are summarised in Table 4 and FIG. 6.

Thus, the experimental doses/treatments were as follows:
100%: 0.04 mg azadirachtins A+B per seed (Cs 100% in FIG. 6),
75%: 0.03 mg azadirachtins A+B per seed (Cs 75% in FIG. 6)
50%: 0.02 mg azadirachtins A+B per seed (Cs 50% in FIG. 6)
Untreated control: received no treatment at all (‘Control’ in FIG. 6)
Belem 0.8 mg (Cypermethrin): 12 kg/ha granulated product (‘Belem’ in FIG. 6)

TABLE 4
Number of damaged plants out of 100 treated
plants and 100 untreated control plants

| | | | | Untreated | Belem |
|---|---|---|---|---|---|
| Repeat No. | 100% | 75% | 50% | control | 0.8 mg |
| 1. Out of 100 plants | 3 | 2 | 16 | 30 | 3 |
| 2. Out of 100 plants | 1 | 0 | 14 | 20 | 10 |
| 3. Out of 100 plants | 2 | 3 | 12 | 47 | 15 |
| 4. Out of 100 plants | 3 | 3 | 20 | 38 | 8 |
| Out of a total of 400 plants | 9 | 8 | 62 | 135 | 36 |
| % | 2.25 | 2 | 15.5 | 33.75 | 9 |

The diagram in FIG. 6 demonstrates that the highest degree of damage was detected in the untreated control parcel (marked as ‘Control’ in FIG. 6) showing damage in 33.75% of the plants; this was followed by treatment Cs 50%, where 15.5% of the plants were damaged despite the treatment. The best results were obtained with treatments Cs 100% and Cs 75% showing 2.25% and 2% damaged plants, respectively; this is followed by Belem, an authorised and currently commercially available product comprising cypermethrin as an active ingredient (9%).

A statistical analysis showed that the treatments were successful, and each treatment showed significant difference in comparison with the untreated control. The analysis demonstrated that treatment with the 100% dose and the treatment with the 75% dose show significant difference in comparison with the treatment with the 50% dose.

1-24. (canceled)

25. Use of azadirachtin A for controlling a soil-dwelling pest of a field crop by seed dressing of said field crop, wherein the field crop is corn and the soil-dwelling pest is Western corn rootworm larva.

26. The use of claim 25, wherein azadirachtin A is used by seed dressing of the corn at a dose of 0.022-0.7 mg/seed.

27. The use of claim 25, wherein azadirachtin A is used by seed dressing of the corn at a dose of 1.54-49 g/ha.

28. A method for controlling a soil-dwelling pest of a field crop, comprising applying an effective amount of azadirachtin A, or of azadirachtin A and azadirachtin B to seeds of said field crop by seed dressing, and sowing the dressed seeds, wherein the field crop is corn, and wherein the soil-dwelling pest is Western corn rootworm larva.

29. The method of claim 28, wherein azadirachtin A is applied to corn seeds in an amount of 0.022-0.7 mg/seed.

30. The use of claim 25, wherein azadirachtin A is used in combination with azadirachtin B, wherein the mass ratio of azadirachtin A to azadirachtin B is 2.5:1-10:1, and wherein azadirachtin A and azadirachtin B are used by seed dressing preferably at a cumulative dose of 0.022-0.7 mg/seed.

31. The use of claim 25, wherein azadirachtin A is used in combination with azadirachtin B, wherein the mass ratio of azadirachtin A to azadirachtin B is 2.5:1-10:1, and wherein azadirachtin A and azadirachtin B are used by seed dressing at a cumulative dose of 1.54-49 g/ha.

32. The use of claim 26, wherein azadirachtin A is used by seed dressing of the corn at a dose of 1.54-49 g/ha.

33. The use of claim 31, wherein azadirachtin A and azadirachtin B are used by seed dressing at a cumulative dose of 0.022-0.7 mg/seed.

34. The method of claim 28, wherein azadirachtin A is applied at a dose of 1.54-49 g/ha.

35. The method of claim 28, wherein azadirachtin A and azadirachtin B are applied to seeds of the field crop by seed dressing, and the mass ratio of azadirachtin A to azadirachtin B is 2.5:1-10:1.

36. The method of claim 28, wherein azadirachtin A and azadirachtin B are applied to seeds of the field crop by seed dressing in a cumulative amount of 0.022-0.7 mg/seed.

37. The method of claim 35, wherein azadirachtin A and azadirachtin B are applied to seeds of the field crop by seed dressing in a cumulative amount of 0.022-0.7 ng/seed.

38. The method of claim 28, wherein azadirachtin A and azadirachtin B are applied at a cumulative dose of 1.54-49 g/ha.

39. The method of claim 35, wherein azadirachtin A and azadirachtin B are applied at a cumulative dose of 1.54-49 g/ha.

40. The method of claim 36, wherein azadirachtin A and azadirachtin B are applied at a cumulative dose of 1.54-49 g/ha.

41. The method of claim 29, wherein azadirachtin A is applied at a dose of 1.54-49 g/ha.
